(19) United States
(12) Patent Application Publication
(10) Pub. No.: US 2021/0147285 A1
(43) Pub. Date: May 20, 2021

(54) METHOD OF TREATING GLASS SUBSTRATE SURFACES

(71) Applicant: Corning Incorporated, Corning, NY (US)

(72) Inventors: Hideki Kobayashi, Kakegawa (JP); Yasuyuki Mizushima, Kakegawa (JP); Hisanori Nakanishi, Hamamatsu City (JP)

(21) Appl. No.: 16/622,601

(22) PCT Filed: Jun. 15, 2018
(86) PCT No.: PCT/US2018/037711

§ 371 Date: Dec. 13, 2019

Related U.S. Application Data
(60) Provisional application No. 62/520,928, filed on Jun. 16, 2017.

(51) Int. Cl. C03C 15/00

(52) U.S. Cl. CPC C03C 15/00

(57) ABSTRACT

Manufacturing method of the glass substrate suitable for flat panel display having upper and lower major surfaces. While the glass substrate is conveyed, the lower surface is treated by two continuous process steps; i) contact with dry HF gas, where the dry HF gas can be generated by atmospheric pressure plasma enhancement, and ii) contact with wet aqueous solution including HF, to achieve average surface roughness determined by AFM to be in a range of 0.5 to 1.5 nm.

This application claims the benefit of priority under 35 U.S.C. § 119 of U.S. Provisional Application Ser. No. 62/520,928 filed on Jun. 16, 2017, the content of which is relied upon and incorporated herein by reference in its entirety.

### TECHNICAL FIELD

The disclosure generally relates to a method of treating glass substrate surfaces, and more particularly to a method of treating glass substrate surfaces by use of a combination of atmospheric pressure plasma enhancement and wet etching.

### BACKGROUND

Glass substrates are widely used for flat panel displays. For instance, a liquid crystal display (LCD) is made of very thin layer of liquid crystalline sandwiched by two glass backplanes, so-called, thin film transistor (TFT)-backplane and color filter (CF)-backplane. One category of glass commonly used in LCD applications is alkali-free glass. Alkali-free glass is generally free of alkali metal oxides and is commonly used as the backplanes for LCD and organic light emitting diode (OLED) applications. These glasses need to have high strain points because these backplanes are heated up to a temperature of several hundreds of degrees C. during the film forming process or annealing, and the change of shape or dimension thereof during the TFT forming process should be minimized. Other considerations for LCD backplanes include: (1) inertness of glass, stability against chemicals, such as acidic solutions used during a photolithographic etching process, (2) surface cleanness free of foreign materials or particles on the glass surface and stability of glass during the longtime storage before use, and (3) electrostatic charge (ESC) or electrostatic discharge (ESD) and stickiness on the substrate plate. Such considerations are especially important during and after the high temperature TFT processes. To address these considerations, the B-side glass surface, namely the down-facing surface where the glass is conveyed horizontally or the surface processed where the glass is fed vertically, can be roughened to reduce the contact area between the glass sheet and the substrate plate. That is, in the high temperature TFT processes, ESC caused by the contact of B-side glass surface with the substrate plate can extend up to A-side glass surface by induction, and can cause ESD within the TFT on the A-side glass surface. Such ESC can be minimized by roughening B-side glass surface. It can be achieved by wet chemical etching of B-side glass surface and the surface roughness (Ra) can be obtained by atomic force microscope (AFM).

However, there is continued need for glass substrates having high surface roughness (defined herein as Ra>0.5 nm) with fast line speed, shorter treatment time and zone length and relative uniformity.

### SUMMARY

The present disclosure provides a method for manufacturing a flat panel display glass substrate having a first surface on one side and a second surface on the other side thereof, the method comprising:
placing the glass substrate on conveying rollers such that the second surface is in contact with the conveying rollers; and
while conveying the glass substrate,
   (i) bringing the second surface into contact with a process gas comprising HF gas that is generated by atmospheric-pressure plasma (APPE), and
   (ii) bringing the second surface into contact with an aqueous solution containing HF, wherein (i) and (ii) are performed successively in no particular order and result in the second surface having a surface roughness of not less than 0.5 nm and not more than 1.5 nm.

The method may further include the steps of washing the second surface with deionized water, rinsing the second surface, and drying the second surface.

As a result, by use of a combination of APPE and wet etching, it is possible to achieve a surface roughness of Ra>0.5 nm with fast line speed, shorter treatment time and zone length, and relative uniformity. Specifically, advantages may include: i) high line speed in range of 5 meters per minute to 20 meters per minute, such as 10 meters per minute to 20 meters per minute; ii) surface roughness Ra in a range of 0.5 nm to 1.5 nm; and iii) variation of Ra of from 0.3 to 2.0 nm.

The conveyance speed is preferably not less than 5 meters per minute and not more than 20 meters per minute.

The glass substrate may be produced by a fusion draw process.

The glass substrate preferably comprises alkali-free glass.

The glass substrate may be heated to a temperature not less than 25° C. and not more than 70° C. prior to the first step.

The process gas containing HF gas may contain, as a carrier gas, at least one of nitrogen and argon.

The step of washing the second surface with deionized water may comprise washing the first surface at the same time, whereby providing the first surface having a surface roughness of not less than 0.15 nm and not more than 0.3 nm.

The first surface preferably has a surface roughness of not less than 0.2 nm and not more than 0.3 nm.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate an embodiments, and together with the description serve to explain principles and operation of the various embodiments. Directional terms as used herein—for example, up, down, right, left, front, back, top, bottom—are made only with reference to the figures as drawn and are not intended to imply absolute orientation.

### BRIEF DESCRIPTION OF THE DRAWINGS

FIG. 1 is an exemplary schematic diagram of process step i) contact with dry HF gas enhanced by atmospheric plasma, and

FIG. 2 is an exemplary schematic diagram of process step ii) contact with wet aqueous solution containing HF.

### DETAILED DESCRIPTION

Reference will now be made in detail to the present embodiments, examples of which are illustrated in the accompanying drawings. Whenever possible, the same reference numerals will be used throughout the drawings to refer to the same or like parts. Ranges can be expressed herein as from one particular value, and/or to another particular value. When such a range is expressed, another embodiment includes from the one particular value and/or to the other particular value. It will be further understood that the endpoints of each of the ranges are significant both in relation to the other endpoint, and independently of the other endpoint.

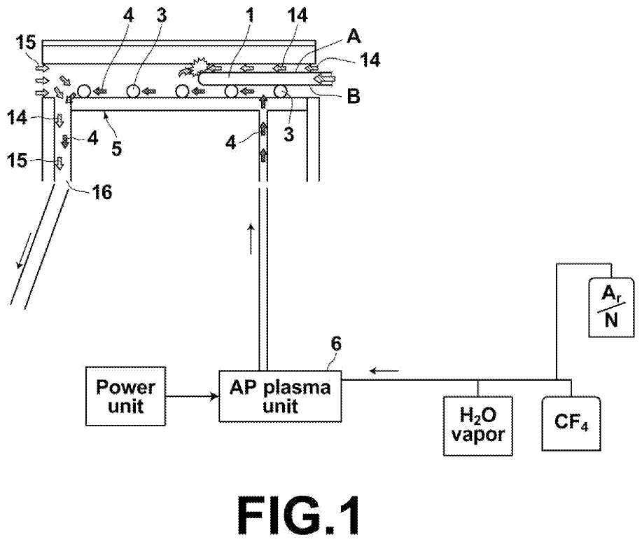

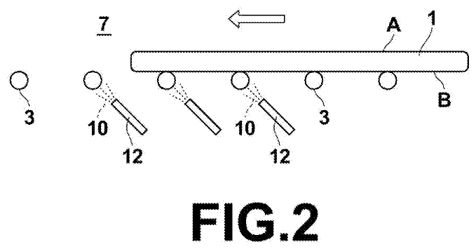

Referring to FIGS. 1 and 2, the glass substrate 1 includes first major surface (otherwise referred to herein as upper surface A) and second major surface (otherwise referred to herein as lower surface B). Upper surface A (“A-side glass surface”) is a surface ultimately intended to be proximate to components such as electrode wires and various electronic devices, while the lower surface B (“B-side glass surface”) is on the opposite side of glass substrate 1 as upper surface A and, as shown in FIG. 1, is in contact with a conveyance device, specifically conveyer rollers 3. B-side glass surface is defined as a down-facing surface where the glass substrate 1 is conveyed horizontally or a processed surface where the glass substrate 1 is fed vertically.

While the glass substrate 1 is moved by conveyer rollers 3 through a nozzle unit 5 (FIG. 1) and through a wet etching zone 7 (FIG. 2), the conveyer speed may, for example, range from 5 meters per minute to 20 meters per minute. A conveyer speed lower than 5 meters per minute may be economically undesirable. A conveyer speed higher than 20 meters per minute may increase the risk of damaging the glass sheet. Meanwhile, B-side glass surface is treated by two continuous process steps:
(i) dry hydrofluoric acid (HF) gas etching using a dry etching nozzle unit 5, where the dry HF gas 4 can be generated by atmospheric pressure plasma enhancement unit 6; and
(ii) wet etching using aqueous solution 10 containing HF spouted from nozzles 12 arranged along a path of the glass substrate 1, wherein steps (i) and (ii) are performed successively in no particular order. That is, the wet etching zone 7 may be located upstream or downstream of the dry etching nozzle unit 5. Performance of the above process steps can achieve an average surface roughness determined by AFM, as described herein, in a range of from 0.5 nm to 1.5 nm.

Following performance of steps (i) and (ii), the substrate is subjected to further treatment that includes deionized (DI) water washing, rinsing and drying of at least lower surface B (not shown).

In the embodiment illustrated in FIGS. 1 and, 2, the dry HF gas 4 moves along the glass substrate 1 while the upper surface A is prevented from being exposed to the HF gas 4 by air flows 14 and 15 flowing into the space over the upper surface A and the dry HF gas 4 and the air flows 14 and 15 are exhausted out of the outlet 16 of the nozzle unit 5.

As further illustrated in FIG. 2, in the wet etching zone 7, the glass substrate 1 is conveyed by sponge conveyer rollers 3 which are wetted by aqueous HF solution 10 spouted from nozzles 12, whereby the lower surface B is wet by the HF solution 10 to perform the wet etching (ii).

The glass substrate can, for example, be produced by a fusion-draw method. The glass substrate may also be produced by other processes such as float processes, slot draw processes, up-draw processes, and press-rolling processes, to name a few.

The glass substrate can, for example, include alkali-free glass, including, for example, a substrate comprising Corning Eagle® XG or Lotus® NXT glass. The glass thickness may, for example, be 0.1 mm to 1.0 mm. The glass size may, for example, be 1 square meter or larger.

In this manufacturing method shown in FIGS. 1 and 2, the glass substrate moved by conveyer rollers 3, with the conveyer speed in range of from 5 meters per minute to 20 meters per minute, and is treated by two continuous process steps (i) and (ii).

In the process, the step (i) comprises dry HF gas etching, where the dry HF gas can be generated by atmospheric pressure plasma enhancement. Commercially available atmospheric plasma etching enhancement devices can be used with embodiments disclosed herein in order to treat lower surface B. Exemplary atmospheric plasma etching enhancing devices include AP-E series devices supplied by Sekisui Chemical Co., Ltd.

For the atmospheric plasma device, fluorine-containing gas such as CF₄ can be used with water, H₂O vapor. After passing the plasma zone, the gas mixture will yield process gas comprising gaseous HF 4. As a part of process gas or carrier gas, argon (Ar) or nitrogen (N) may be used. In certain exemplary embodiments, the glass substrate 1 may be at first preheated at 25-70 degrees C. and then treated by the dry HF gas 4, generated by atmospheric plasma device 6. With this heat pretreatment, the Ra variation can be controlled to be within a range of 0.2 nm to 0.3 nm. In contrast, if the temperature is below 25 degrees C., the Ra variation can be greater. Conversely, if the temperature is above 70 degrees C., undesirable pits and holes may appear on the glass surface. The treatment time of glass by the plasma etching process can be, for example, in a range of 0.1 seconds to 5 minutes. The line speed, can, for example, be in a range of 5 meters per minute to 20 meters per minute, such as 10 meters per minute to 20 meters per minute.

In the process, the step (ii) comprises treatment with wet aqueous solution 10 comprising HF. The HF concentration may, for example, be in a range of 0.1 wt % to 5 wt %. The glass substrate may, for example, be kept at the temperature range of 25-70 degree C. during the roller conveyance.

The aqueous HF solution 10 may comprise other acids, such as, for example, at least one of H₂SO₄, HCl, and H₃PO₄. It may also be buffered. That is, a buffer solution such as a mixture of NaF and H₃PO₄ or acetic acid may be used to maintain HF produced in an equilibrium state.

Embodiments disclosed herein can achieve an average surface roughness Ra for lower surface B of 0.5 nm to 1.5 nm, as measured by AFM, as described herein.

Embodiments disclosed herein can also achieve an average surface roughness Ra for upper surface A of 0.15 nm to 0.3 nm, such as is 0.2 nm to 0.3 nm. Such can be achieved by, for example, washing the surface by DI water or alkaline-containing detergent. With the washing and drying, lower surface B can be cleaned to remove some solid particles and etching vapor residues comprising HF from the lower surface B surface treatment process.

Although in the above described embodiment, the glass substrate 1 is conveyed horizontally, it may be conveyed partly or entirely in a vertical or inclined path. In such a case, the B-side glass surface B, which may not be down facing, is exposed to the dry HF gas 4 in step (i) and to the aqueous HF solution 10 in step (ii).

### Examples

Glass A, Corning Eagle® XG glass, and glass B, Corning Lotus® NXT glass, each having a thickness of 0.5 mm and a major surface area of about 300 mm×400 mm were subjected to the conditions shown in Table 1. Prior to treatment set forth below as steps (i) and (ii), each glass was preheated to about 40 degrees C.S then steps (i) and (ii) were carried out while the glass was conveyed at the line speeds shown in Table 1.

In the step (i), a mixture of gases having a feed rate of 10 liters per minute of Argon, 0.8 liters per minute of CF₄, and 180 milligrams per minute of water vapor were used. Atmospheric plasma was applied at 4 KW to yield dry HF gas. Air flow was used at about 200 liters per minute to prevent process gas from leaking out of the device together with exhaust gas flow. The resulting dry process gas comprising HF gas was applied to the lower surface B of each sample.

In step (ii), a solution comprising 0.09M NaF and 0.11M H₃PO₄ was used. The solution was applied to the conveyed glass through sponge rollers 3.

After the steps (i) and (ii), the glass was conveyed to a washing zone and washed with city water. Both upper surface A and lower surface B were washed in the washing zone. After that, the both glass surfaces were rinsed with DI water and dried by air flow.

### Comparable Examples

Comparative examples 1 and 2 (C1 and C2) were performed as described above except without step (i). Comparative example 3 (C3) was performed as described above except without step (ii).

TABLE 1

| | | Line | | | Ra (nm) | Ra (nm) |
|---|---|---|---|---|---|---|
| | | speed | i) time | ii) time | on | on |
| Example | Glass * | (m/min.) | (sec) | (sec) | B-side | A-side |
| 1 | A | 7.6 | 1 | 44 | 0.72 | 0.21 |
| 2 | A | 12.7 | 1 | 44 | 0.65 | 0.21 |
| 3 | B | 7.6 | 1 | 44 | 1.03 | 0.21 |
| C1 | A | 7.6 | 0 | 44 | 0.49 | 0.2 |
| C2 | A | 12.7 | 0 | 44 | 0.46 | 0.2 |
| C3 | B | 7.6 | 1 | 0 | 0.98 | 0.21 |

* Glass A: Corning Eagle XG; Glass B: Lotus NXT.

### Surface Roughness Determination

Ra for embodiments disclosed herein was obtained by Hitachi High-Tech AFM5400L. Surface morphology image of AFM was scanned with Dynamic Force Mode (DFM). Cantilever SI-DF20P2 (Spring constant=9 N/m, Resonance frequency: 100-200 kHz, Radius of tip: 7 nm, tip height: 14 um, lever length: 160 um, lever width: 40 um, lever thickness: 3.5 um) was used. Soft X-ray was irradiated onto the glass surface during the measurement for discharging the glass surface.

Table 2 shows the parameter of the AFM measurement. The average Ra was taken from 18 measurements.

TABLE 2
AFM measurement parameter

| Parameter | Value |
|---|---|
| Integral gain | 0.2 |
| Proportional gain | 0.05 |
| Z limit | 500 nm |
| Scanning area | 10 um × 10 um |
| Image quality | X -axis: 256 |
| | Y-axis: 256 |

It will be apparent to those skilled in the art that various modifications and variations can be made without departing from the spirit and scope of the disclosure. Thus it is intended that the present disclosure cover such modifications and variations provided they come within the scope of the appended claims and their equivalents.

What is claimed is:

1. A method for manufacturing a glass substrate having first and second major surfaces on opposite sides thereof, the method comprising:
placing the glass substrate on a conveyance device with the first major surface faced upward; and
while conveying the glass substrate,
(i) contacting the second major surface with a process gas comprising hydrofluoric acid (HF) gas that is generated by atmospheric-pressure plasma, and
(ii) contacting the second major surface with an aqueous solution comprising HF, wherein (i) and (ii) are performed successively in no particular order and result in
the second major surface having a surface roughness (Ra) of not less than 0.5 nm and not more than 1.5 nm.

2. The method of claim 1 further comprising:
washing the second major surface with deionized water, rinsing the second major surface, and drying the second major surface.

3. The method of claim 1, wherein the conveyance speed is not less than 5 meters per minute and not more than 20 meters per minute.

4. The method of any of claim 1, wherein the glass substrate is produced by a fusion draw process.

5. The method of claim 1, wherein the glass substrate comprises alkali-free glass.

6. The method of claim 1, wherein the glass substrate is heated to a temperature not less than 25° C. and not more than 70° C. prior to the first step.

7. The method of claim 1, wherein the process gas comprising HF gas comprises, as a carrier gas, at least one of nitrogen and argon.

8. The method of claim 1, wherein washing the second major surface with deionized water comprises washing the first major surface at the same time, wherein performance of the first and second steps results in the first major surface having a surface roughness of not less than 0.2 nm and not more than 0.3 nm.
